(19) United States
(12) Patent Application Publication
(10) Pub. No.: US 2009/0317146 A1
(43) Pub. Date: Dec. 24, 2009

(54) IMAGE FORMING APPARATUS

(75) Inventor: Ryohei OHTSUKI, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Kyoto-shi (JP)

(21) Appl. No.: 12/436,899

(22) Filed: May 7, 2009

(30) Foreign Application Priority Data
Jun. 23, 2008 (JP) 2008-163867

(51) Int. Cl. G03G 15/01

(52) U.S. Cl. 399/299; 399/302

(57) ABSTRACT

An image forming apparatus includes a plurality of image forming units arranged to form toner images of different colors on surfaces of photoconductive drums, an intermediate transfer unit that has an intermediate transfer belt arranged in the vicinity of the photoconductive drums and a plurality of intermediate transfer rollers opposed to the respective photoconductive drums through the intermediate transfer belt, and that transfers the toner images formed on the photoconductive drums to the intermediate transfer belt, and a transfer unit arranged to transfer, to a piece of paper, the toner images of different colors transferred to the intermediate transfer belt. The intermediate transfer unit includes a position setting mechanism arranged to move the intermediate transfer rollers individually to an operation position in which the roller makes contact with the intermediate transfer belt to be close to the photoconductive drum or to a stand-by position in which the roller is separated away from the intermediate transfer belt to be retreated from the photoconductive drum.

### CROSS-REFERENCE TO RELATED APPLICATIONS

This application claims priority under 35 U.S.C. 119 to Japanese Patent Application No. 2008-163867, filed on Jun. 23, 2008, which application is hereby incorporated by reference in its entirety.

### BACKGROUND OF THE INVENTION

1. Field of the Invention

The present invention relates to an image forming apparatus such as a copier, a facsimile machine, a printer, or the like.

2. Description of the Related Art

An image forming apparatus employs an electrophotographic system that forms an electrostatic latent image on a surface of a photoconductive drum, visualizes the image through toner, performs an image forming process by transferring the formed toner image on a paper, and fixes the transferred toner image to the paper.

When forming a color image by an image forming apparatus employing the electrophotographic system, a system (transfer drum system) is used in which a paper is wound around a transfer drum, and toner images are repeatedly transferred to the wound paper from a plurality of image forming units arranged to form toner images of different colors on surfaces of photoconductive drums. In addition to the above system, a system (intermediate transfer system) has been used in which toner images are temporarily transferred from a plurality of image forming units to an intermediate transfer belt to form a color toner image, and then the formed color toner image is transferred to a paper.

An image forming apparatus employing the intermediate transfer system includes, for example, an intermediate transfer belt that is horizontally tensioned by a tension roller; a chromatic-image forming station having a photoconductive drum opposed thereto, the chromatic-image forming station being located at a planar portion on an upper side of the intermediate transfer belt; and a black-image forming station having a photoconductive drum opposed thereto, the black-image forming station being located at a planar portion on a lower side of the intermediate transfer belt. In such an apparatus, only the photoconductive drum that is opposed to the planar portion on the upper side is separated away from the intermediate transfer belt at the time of forming a black unicolor image.

In such a conventional image forming apparatus, the photoconductive drum that does not perform an image forming process is separated away from the intermediate transfer belt by moving the intermediate transfer belt. Therefore, the photoconductive drum is not always in contact with the intermediate transfer belt, which thereby can extend the lifetime of the photoconductive drum. However, an intermediate transfer roller opposed to the photoconductive drum is always in contact with the intermediate transfer belt, and thus a problem arises in that the deterioration of the intermediate transfer roller due to the contact is rapid, decreasing the lifetime thereof.

### SUMMARY OF THE INVENTION

In order to overcome the problems described above, preferred embodiments of the present invention provide an image forming apparatus that can extend the lifetime of an intermediate transfer roller.

According to a preferred embodiment of the present invention, an image forming apparatus includes a plurality of image forming units, an intermediate transfer unit, and a transfer unit. The plurality of image forming units form toner images of different colors on surfaces of photoconductive drums. The intermediate transfer unit includes: (i) an intermediate transfer belt arranged in the vicinity of the photoconductive drums, and (ii) a plurality of intermediate transfer rollers opposed to the respective photoconductive drums via the intermediate transfer belt, and transfers toner images formed on the photoconductive drums to the intermediate transfer belt. The transfer unit transfers the toner images of different colors transferred to the intermediate transfer belt to a piece of paper. The intermediate transfer unit includes a position setting mechanism that individually moves the intermediate transfer rollers to an operation position or to a stand-by position. In the operation position, the intermediate transfer roller makes contact with the intermediate transfer belt to be close to the photoconductive drum. In the stand-by state, the intermediate transfer roller is separated away from the intermediate transfer belt to be retreated from the photoconductive drum. The position setting mechanism moves only the intermediate transfer roller that is opposed to the image forming unit that forms a black toner image to the operation position. Further, the position setting mechanism simultaneously moves the plurality of intermediate rollers opposed to the plurality of image forming units that form toner images other than the black toner images to the operation position. Furthermore, the position setting mechanism includes an operation member arranged to position the intermediate transfer rollers individually in the operation position or in the stand-by position and a transferring member arranged to reciprocate the operation member for positioning the intermediate transfer rollers.

In the above configuration, since the position setting mechanism moves the intermediate transfer rollers individually to the operation position in which the roller makes contact with the intermediate transfer belt to be close to the photoconductive drum or to the stand-by position in which the roller is separated away from the intermediate transfer belt to be retreated from the photoconductive drum, the intermediate transfer rollers that are not used in an image forming process can be individually retreated to the stand-by position so as to not make contact with the intermediate transfer belt. As a result, the intermediate transfer rollers are not always in contact with the intermediate transfer belt, which can thereby extend the lifetime of the intermediate transfer rollers.

By moving only the intermediate transfer roller that is opposed to the image forming unit that forms a black toner image to the operation position, the black image forming process, which is frequently performed, can be individually handled. Similarly, by simultaneously moving the plurality of intermediate transfer rollers that are opposed to the plurality of image forming units that form color toner images other than black toner images to the operation position, the color image forming process can be individually handled.

By providing the operation member arranged to position the intermediate transfer rollers individually in the operation position or in the stand-by position and the transferring member arranged to reciprocate the operation member as the position setting mechanism, the intermediate transfer rollers can be reliably and individually positioned with a simple configuration.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic view of an entire image forming apparatus according to a preferred embodiment of the present invention.

FIG. 2 is a perspective view of a position setting mechanism according to a preferred embodiment of the present invention.

FIG. 3 is an enlarged perspective view of an axis supporting member and a supporting member according to a preferred embodiment of the present invention.

FIG. 4 is an exploded perspective view of the axis supporting member and the supporting member.

FIG. 5A illustrates an operation performed when a slide member is moved to set a position of an intermediate transfer roller according to a preferred embodiment of the present invention.

FIG. 5B illustrates an operation performed when the slide member is moved to set the position of the intermediate transfer roller.

FIG. 5C illustrates an operation performed when the slide member is moved to set the position of the intermediate transfer roller.

### DETAILED DESCRIPTION OF PREFERRED EMBODIMENTS

Preferred embodiments of the present invention will now be described. The preferred embodiments described below merely preferable examples of the present invention. However, the present invention is not limited to these preferred embodiments.

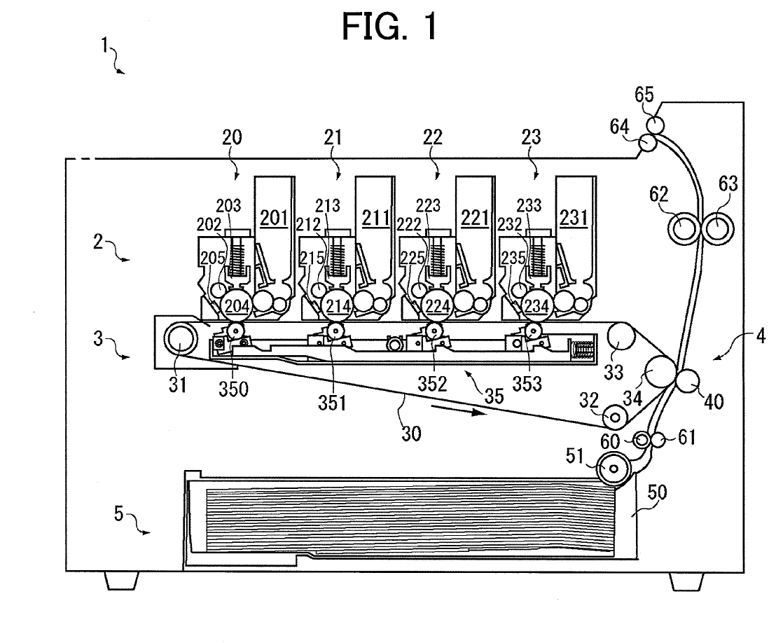

FIG. 1 is a schematic configuration view according to a preferred embodiment of the present invention. An image forming apparatus 1 preferably includes an image forming unit 2, an intermediate transfer unit 3, a transfer unit 4, and a paper feeding unit 5 in a chassis.

The image forming unit 2 preferably includes a plurality of image forming units 20 through 23 arranged to form toner images of different colors on respective surfaces of photoconductive drums. The image forming unit 20 is preferably arranged to form a black toner image, and preferably includes a developing unit 201, a charging roller 202, an exposure head 203, a photoconductive drum 204, and a memory removing brush 205. The surface of the photoconductive drum 204 is uniformly charged by the charging roller 202, the exposure head (preferably defined by a Light Emitting Diode head: LED head) 203 exposes the surface of the charged photoconductive drum in accordance with an image recording signal, and thus an electrostatic latent image is formed. Then, toner in the developing unit 201 is transferred by a supply roller and a developing roller to the electrostatic latent image formed on the photoconductive drum 204 to visualize the image. Then, the toner image formed on the surface of the photoconductive drum 204 is transferred by a later-described intermediate transfer roller to a later-described intermediate transfer belt.

Thus, a series of charging, exposing, developing, and transferring processes with respect to the photoconductive drum 204 are performed in which the black toner image is formed and transferred to the intermediate transfer belt. After the transfer, the adherence of the residual toner on the surface of the photoconductive drum 204 is reduced by the memory removing brush 205 (eraser brush), and the residual toner is scattered on the surface of the photoconductive drum 204 and then collected by the developing roller of the developing unit 201.

The image forming units 21 through 23 are arranged to form the toner images for color image forming. The image forming unit 21 is preferably arranged to form a yellow toner image on the surface of the photoconductive drum, and similarly to the image forming unit 20, preferably includes a developing unit 211, a charging roller 212, an exposure head 213, a photoconductive drum 214, and a memory removing brush 215. Also similarly to the image forming unit 20, a series of charging, exposing, developing, and transferring processes with respect to the photoconductive drum 214 are performed in which the yellow toner image is formed and transferred to the intermediate transfer belt.

The image forming unit 22 is preferably arranged to form a magenta toner image on the surface of the photoconductive drum, and similarly to the image forming unit 20, preferably includes a developing unit 221, a charging roller 222, an exposure head 223, a photoconductive drum 224, and a memory removing brush 225. Also similarly to the image forming unit 20, a series of charging, exposing, developing, and transferring processes with respect to the photoconductive drum 224 are performed in which the magenta toner image is formed and transferred to the intermediate transfer belt.

The image forming unit 23 is preferably arranged to form a cyan toner image on the surface of the photoconductive drum, and similarly to the image forming unit 20, preferably includes a developing unit 231, a charging roller 232, an exposure head 233, a photoconductive drum 234, and a memory removing brush 235. Also similarly to the image forming unit 20, a series of charging, exposing, developing, and transferring processes with respect to the photoconductive drum 234 are performed in which the cyan toner image is formed and transferred to the intermediate transfer belt.

The image forming units 20 through 23 are preferably aligned in a horizontal direction, and on lower surfaces thereof, the photoconductive drums 204 through 234 are partially exposed downwardly.

The intermediate transfer unit 3 preferably includes an endless intermediate transfer belt 30, intermediate transfer rollers 350 through 353, and a position setting mechanism 35. The intermediate transfer belt 30 is tensioned by a drive roller 31, driven rollers 32, 33, and a supporting roller 34, and is rotationally transported when the drive roller 31 is rotationally driven. A transportation path of the intermediate transfer belt 30 transported from the driven roller 33 to the drive roller 31 is located in such a manner that the belt 30 comes closer at predetermined intervals to each of the photoconductive drums 204 through 234, which are exposed at the lower surfaces of the image forming units 20 through 23.

The position setting mechanism 35 arranged to support the intermediate transfer rollers 350 through 353 is preferably provided inside the tensioned intermediate transfer belt 30. The intermediate transfer rollers 350 through 353 are aligned on a lower surface side of the intermediate transfer belt 30 in such a manner that the rollers 350 through 353 are opposed to the photoconductive drums 204 through 234, respectively.

By elevating operation positions of the intermediate transfer rollers 350 through 353 by operating the position setting mechanism 35, which will be explained later, the rollers 350 through 353 arranged to press the lower surface of the intermediate transfer belt 30 up such that the rollers 350 through 353 are pressed against the respective photoconductive drums 204 through 234 via the intermediate transfer belt 30. Transfer voltage is applied from an unillustrated voltage applying circuit to the intermediate transfer rollers, and when the intermediate transfer belt 30 is driven in synchronization with the rotation speed of each of the photoconductive drums, the toner image formed on each of the surfaces of the photoconductive drums are transferred to the surface of the intermediate transfer belt 30.

The paper feeding unit 5 is arranged to feed pieces of paper, which are stacked in a paper feed cassette 50, one sheet at a time through a paper feed roller 51. The fed paper is nipped by a transportation roller 60 and a press roller 61 and transported to the transfer unit 4. A transfer roller 40 is arranged to be opposed to a support roller 34 in the transfer unit 4, and prescribed transfer voltage is applied to the transfer roller 40 by the unillustrated voltage applying circuit. While the transported paper is nipped between the transfer roller 40 and the intermediate transfer belt 30 and transported, the toner image supported by the intermediate transfer belt 30 is transferred to the paper.

The paper having the toner image transferred thereto is nipped between a fixing roller 62 and a press roller 63, and a fixing process is performed on the paper. Then, the paper having the toner image fixed thereto is nipped between a discharge roller 64 and a press roller 65 and discharged onto a discharge tray.

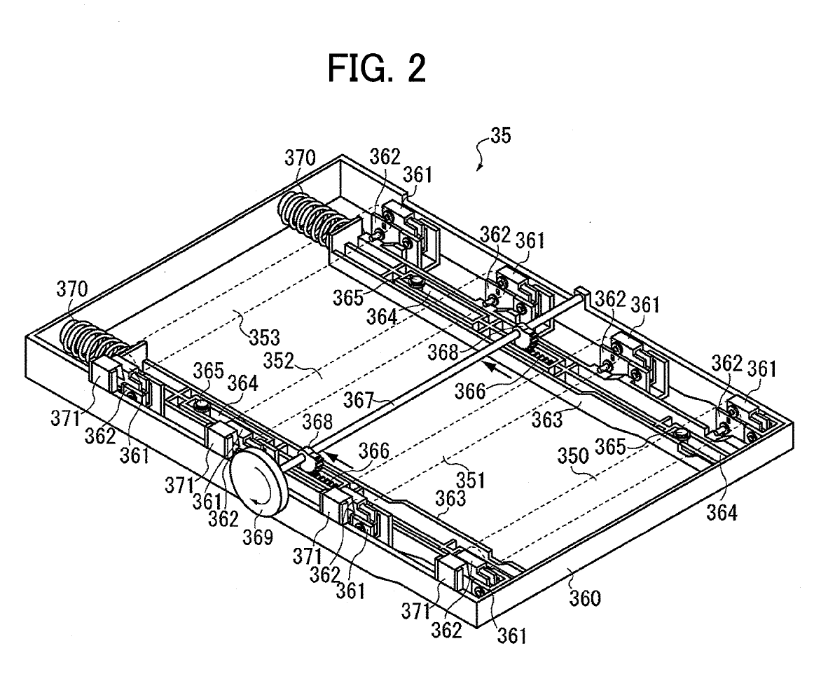

FIG. 2 is a perspective view of the position setting mechanism 35. In the position setting mechanism 35, the intermediate transfer rollers 350 through 353 are aligned at equal intervals inside a box-shaped supporting frame 360. Axis supporting members 361 and supporting members 362 are aligned on both side portions of the supporting frame 360. Each axis supporting member 361 is arranged to axially support a rotation axis protruding from both ends of each of the intermediate transfer rollers such that the rotation axis can rotate. The supporting members 362 swingably support the respective axis supporting members 361.

Slide members 363 are provided on inner sides of the supporting members 362 inside the supporting frame 360 to swing and position the axis supporting members 361 and the supporting members 362. Each of the slide members 363 preferably has a slide slot 364 arranged in a direction that is perpendicular or substantially perpendicular to the axial direction of the intermediate transfer roller. Guide pins 365 provided to the supporting frame 360 are fitted to the slide slots 364 so that the slide members 363 can slide in the perpendicular direction.

A drive axis 367 is axially supported along the axial direction of the intermediate transfer roller in full width at a central portion of the supporting frame 360. Cutout gears 368 are fixed to the drive axis 367 to be engaged with respective rack teeth 366 arranged at a central portion of the respective slide members 363. One end portion of the drive axis 367 protrudes externally from the supporting frame 360 and has a drive gear 369 attached thereto.

A compression spring 370 is preferably attached between one end portion of each of the slide members 363 and an inner surface of the supporting frame 360. Another end portion of each of the slide members 363 is always biased by the biasing force of the respective compression springs 370 to be pressed against the inner surface of the supporting frame 360.

When the drive gear 369 is rotationally driven in the direction of arrow (i.e., in the clockwise direction), the cutout gears 368 rotate while engaging with the rack teeth 366, and move the slide members 363 to the direction of arrow against the biasing force of the compression springs 370. When the cutout gears 368 are rotated by a prescribed angle and disengaged from the rack teeth 366, the slide members 363 return to their initial states by the biasing force of the compression springs 370. When the drive gear 369 is rotated in the same direction until the cutout gears 368 rotate by one revolution to be engaged again with the rack teeth 366, the slide members 363 become movable again.

By rotating the cutout gears 368 in one direction as described above, the slide members 363 can reciprocate in the longitudinal direction.

Power feeding bodies 371 are attached to one of the side portions of the supporting frame 360, and are each arranged to contact with the rotation axis of the corresponding intermediate transfer roller axially supported by the corresponding axis supporting member 361. The power feeding body 371 is preferably defined by a folded metal plate that is exposed at its external side portion to be connected with a power feeding terminal that is connected with the unillustrated voltage applying circuit. An inner side portion of the power feeding body 371 is elastic so that an end portion thereof can be always in contact with an end surface of the rotation axis of the intermediate transfer roller. Therefore, the transfer voltage can be stably applied to each of the intermediate transfer rollers via the corresponding power feeding body 371.

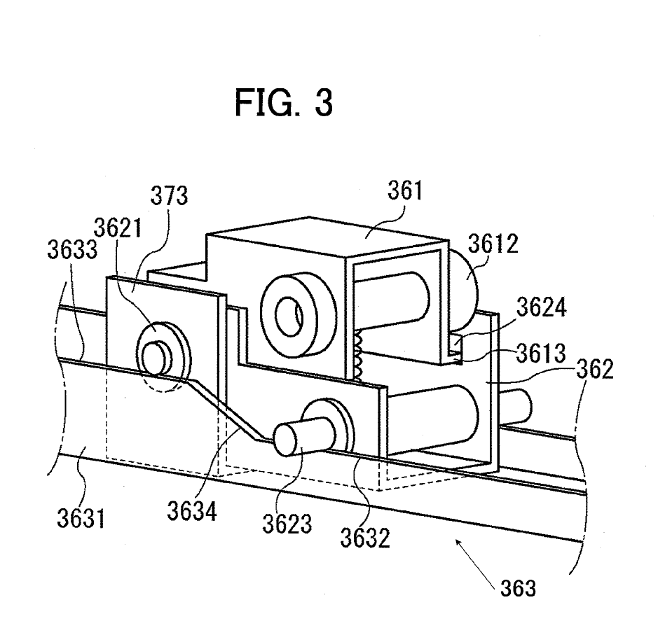

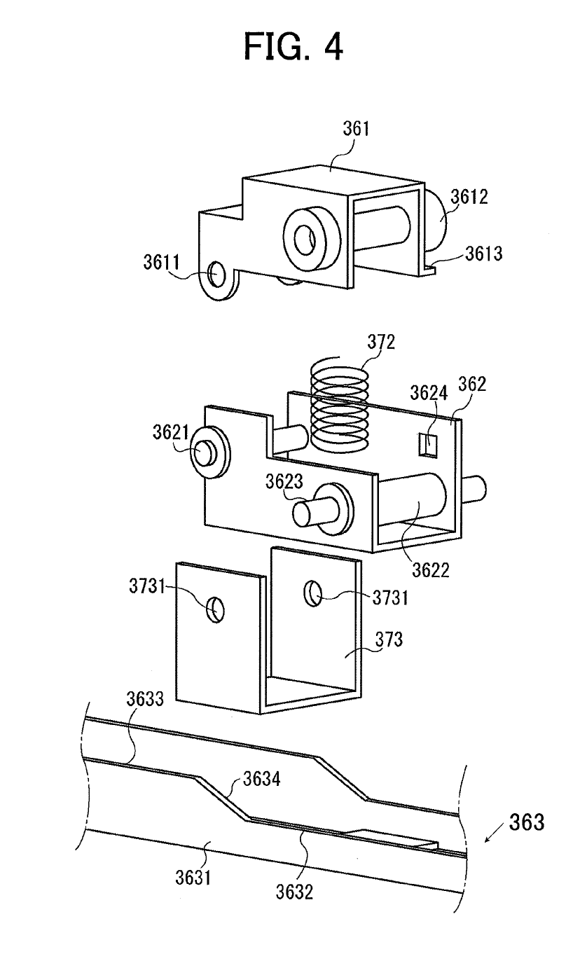

FIG. 3 is an enlarged perspective view of the axis supporting member 361 and the supporting member 362. FIG. 4 is an exploded perspective view of FIG. 3. The axis supporting member 361 has a plate portion folded downwardly at both end portions and an axis supporting hole 3611 defined on one end portion side of each of the end portions. An axis tube member 3612, to which the rotation axis of the intermediate transfer roller is axially attached, is preferably fixed to each of the end portions on another end portion side. An engaging portion 3613 defined by folding a portion of a lower edge of the side portion is preferably provided on the other end portion side.

The supporting member 362 preferably has a plate portion folded upwardly at both end portions and axially supports a swinging axis member 3621 at one end portion side such that the swinging axis member 3621 can swing. An axis tube member 3622 is fixed to another end portion side, and a guide pin 3623 is swingably inserted through the axis tube member 3622. Both end portions of the guide pin 3623 externally protrude from the axis tube member 3622. A rectangular engaging hole 3624 is defined on a side portion of the other end portion side, and the engaging portion 3613 of the axis supporting member 361 is engaged with the engaging hole 3624.

A compression spring 372 is preferably provided between the axis supporting member 361 and the supporting member 362. In the state in which the axis supporting member 361 is axially supported through the axis supporting hole 3611 by the swinging axis member 3621 of the supporting member 362, the axis supporting member 361 is biased by the biasing force of the compression spring 372 to always swing upward. In the state in which the engaging portion 3613 of the axis supporting member 361 is in contact with an upper surface of the engaging hole 3624 of the supporting member 362, the axis supporting member 361 is biased and held.

The supporting member 362 is swingably and axially supported by an attachment frame 373 fixed to a bottom surface of the supporting frame 360. The attachment frame 373 has a plate portion folded upwardly at both end portions, and the swinging axis member 3621 of the supporting member 362 is swingably and axially supported by axis supporting holes 3731 defined on both end portions of the plate portion.

A guide surface of the guide pin 3623 of the supporting member 362 is preferably defined on an upper surface of a side portion 3631 of the slide member 363 on a side of the supporting member 362. The guide surface has a first horizontal surface portion 3632 arranged in a lower horizontal position, a second horizontal surface portion 3633 arranged in a higher horizontal position, and a sloped surface portion 3634 that connects the horizontal surface portions 3632 and 3633.

When the slide member 363 reciprocates, the guide pin 3623 moves vertically in the state in which the guide pin 3623 is in contact between the first horizontal surface portion 3632 and the second horizontal surface portion 3633. Thus, the supporting member 362 vertically swings in synchronization with the vertical movement of the guide pin 3623, and accompanying such movement, an operation position at which the intermediate transfer roller axially supported by the axis supporting member 361 is moved up and a stand-by position at which the intermediate transfer roller is moved down are set.

When the slide member 363 moves in the state in which the guide pin 3623 is in contact with the guide surface, since the guide pin 3623 is swingably held by the axis tube member 3622, the guide pin 3623 is rotated accompanying the movement. Therefore, a transfer resistance is reduced, which thereby realizes smooth movement. Such smooth movement can also be realized by defining a round-shaped boundary portion between the horizontal surface portion and the sloped surface portion of the guide surface.

As described above, by reciprocating the slide members 363, the vertical positions of the intermediate transfer roller can be set.

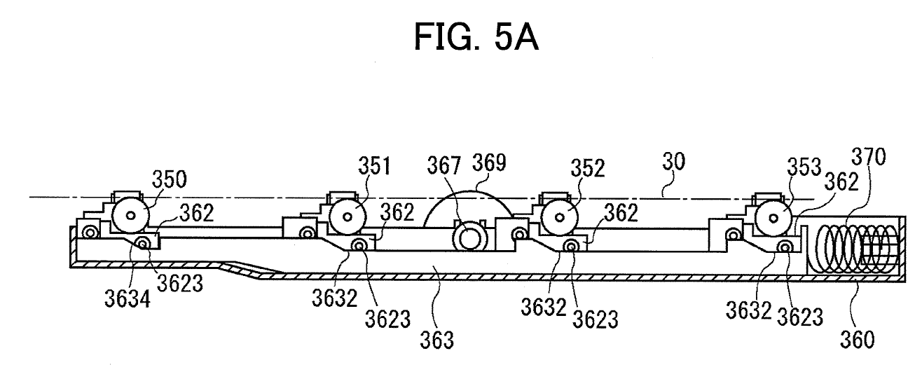

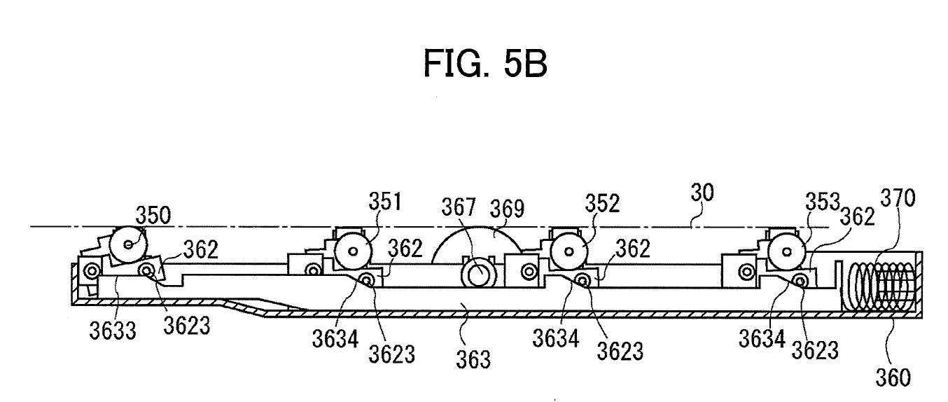

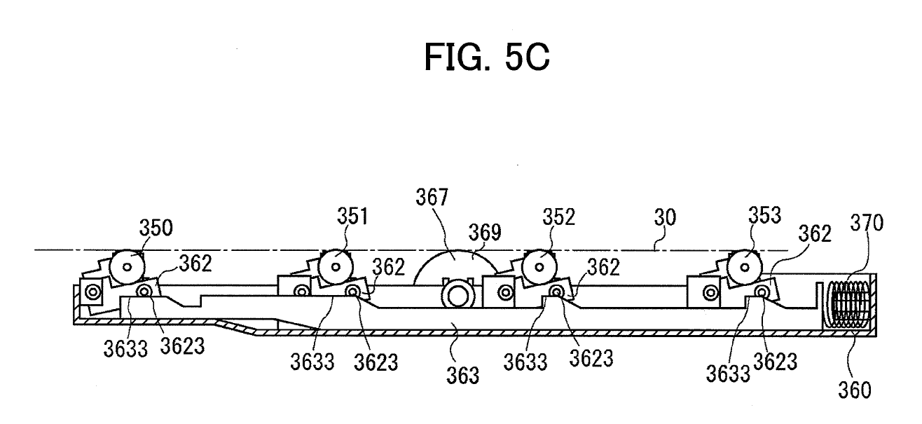

FIGS. 5A through 5C illustrate operations performed when the slide members 363 are moved to set the positions of the intermediate transfer rollers 350 through 353. FIG. 5A illustrates the apparatus in a stand-by state, in which the slide members 363 are moved towards the left by the biasing force of the compression springs 370. In the above state, the guide pin 3623 of each of the supporting members 362 is set to be in contact with the first horizontal surface portion 3632 of the guide surface. Therefore, each of the intermediate transfer rollers is moved down to the stand-by position. In the stand-by position, the intermediate transfer roller is retreated from the opposing photoconductive drum. All the intermediate transfer rollers are in the stand-by state in which the rollers are retreated from the photoconductive drums in FIG. 5A. Although the intermediate transfer belt 30 is in contact with the intermediate transfer rollers, the intermediate transfer belt 30 is not transported and does not slidably make contact with the intermediate rollers while the apparatus is in the stand-by state.

FIG. 5B illustrates a process of forming a black image. As described above, the drive gear 369 is rotationally driven by a prescribed angle to move the slide members 363 towards the right by a prescribed distance. The guide surface is arranged such that only the guide pin 3623 that responds to the intermediate transfer roller 350 is moved to the second horizontal surface portion 3633 by the movement of the slide members 363, and such that the other guide pins 3623 of the intermediate transfer rollers other than the roller 350 are moved to the first horizontal surface portion or to the sloped surface portion. Accordingly, only the intermediate transfer roller 350 is moved up to be in the operation position that is in the vicinity of the photoconductive drum 204. At this time, since the intermediate transfer roller 350 is operated to press up the intermediate transfer belt 30 by making contact with the belt 30, the intermediate transfer rollers 351 through 353, which are in the stand-by position, are separated from the intermediate transfer belt 30. When transporting the intermediate transfer belt 30 in the above state, the intermediate transfer belt 30 does not slidably make contact with the intermediate transfer rollers 351 through 353, which thereby can prevent the rollers 351 through 353 from being deteriorated due to abrasion or the like. Further, since the intermediate transfer belt 30 slidably makes contact only with the photoconductive drum 204 and the intermediate transfer roller 350, the belt 30 can also be prevented from being deteriorated due to abrasions or the like.

FIG. 5C illustrates a process of forming a color image. In this case, the drive gear 369 is further rotationally driven by a predetermined angle to move the slide members 363 further to the right by a predetermined distance. The guide surface is arranged such that the guide pins 3623 that respectively respond to the intermediate transfer rollers 350 through 353 are moved to the second horizontal surface portion 3633 by the movement of the slide members 363. Accordingly, all of the intermediate transfer rollers are moved up to the operation position in the vicinity of the photoconductive drums and press up the intermediate transfer belt 30 by making contact with the belt 30, which is thus transported in the vicinity of all of the photoconductive drums.

When the intermediate transfer rollers are moved up to the operation position, the rollers are pressed downward by making contact with the intermediate transfer belt 30. Therefore, the axis supporting members 361 are operated to move down against the biasing force of the compression springs 372, and the intermediate transfer rollers can be set in the operation position in a stable state by the biasing force of the compression springs 372.

By rotating the drive gear 369 further from the state illustrated in FIG. 5C, the rack teeth and the cutout gears become disengaged, thus returning to the state of FIG. 5A.

In the above-described example, the slide members are moved by the rack teeth and the cutout gears, however, the slide members can be moved by using any other transferring members such as, for example, an air cylinder or the like. Further, by changing the shape of the guide surface of the slide member, the intermediate transfer rollers corresponding to each color can be individually moved vertically, and thus, designs can be easily changed in accordance with the use frequency of each color at the time of forming images.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image forming apparatus comprising:
a plurality of image forming units arranged to form toner images of different colors on surfaces of photoconductive drums;
a transfer unit; and
an intermediate transfer unit including:
an intermediate transfer belt arranged adjacent to the photoconductive drums; and
a plurality of intermediate transfer rollers opposed to the respective photoconductive drums through the intermediate transfer belt; wherein
the intermediate transfer unit is arranged to transfer the toner images formed on the photoconductive drums to the intermediate transfer belt;
the transfer unit is arranged to transfer the toner images of different colors transferred to the intermediate transfer belt to a piece of paper; and
the intermediate transfer unit includes a position setting mechanism arranged to individually move the intermediate transfer rollers to: (a) an operation position in which the roller makes contact with the intermediate transfer belt to be close to the photoconductive drum, or (b) a stand-by position in which the roller is separated away from the intermediate transfer belt to be retreated from the photoconductive drum.

2. The image forming apparatus according to claim 1, wherein the position setting mechanism is arranged to move only the intermediate transfer roller that is opposed to one of the image forming units that is arranged to form a black toner image to the operation position.

3. The image forming apparatus according to claim 1, wherein the position setting mechanism is arranged to simultaneously move at least two of the plurality of intermediate transfer rollers that are opposed to the plurality of image forming units that form color toner images other than black toner images to the operation position.

4. The image forming apparatus according to claim 2, wherein the position setting mechanism is arranged to simultaneously move at least two of the plurality of intermediate transfer rollers that are opposed to the plurality of image forming units that form color toner images other than black toner images to the operation position.

5. The image forming apparatus according to claim 1, wherein the position setting mechanism includes:
an operation member arranged to individually position the intermediate transfer rollers in the operation position or in the stand-by position; and
a transferring member arranged to reciprocate the operation member to position the intermediate transfer rollers.

6. The image forming apparatus according to claim 2, wherein the position setting mechanism includes:
an operation member arranged to individually position the intermediate transfer rollers in the operation position or in the stand-by position; and
a transferring member arranged to reciprocate the operation member to position the intermediate transfer rollers.

7. The image forming apparatus according to claim 3, wherein the position setting mechanism includes:
an operation member arranged to individually position the intermediate transfer rollers in the operation position or in the stand-by position; and
a transferring member arranged to reciprocate the operation member to position the intermediate transfer rollers.
